(19) United States
(12) Patent Application Publication
(10) Pub. No.: US 2021/0216946 A1
(43) Pub. Date: Jul. 15, 2021

(54) SCHEDULE OPTIMIZATION SYSTEM

(71) Applicant: Uplevel, Inc., Seattle, WA (US)

(72) Inventors: Stefan B. Schoenmackers, Albuquerque, NM (US); Anne L. Sallaska, Auburn, WA (US); Eric W. Kuo, Seattle, WA (US); David Youssefnia, Mercer Island, WA (US)

(21) Appl. No.: 17/144,192

(22) Filed: Jan. 8, 2021

Related U.S. Application Data
(60) Provisional application No. 62/959,563, filed on Jan. 10, 2020.

(51) Int. Cl. G06Q 10/06; G06Q 10/10

(52) U.S. Cl. CPC G06Q 10/063116; G06Q 10/1097; G06Q 10/06314; G06Q 10/06312

(57) ABSTRACT

Disclosed embodiments include systems, computer-implemented methods, and computer-readable media for scheduling work sessions for an entity during a period when the entity has previously performed work. In an illustrative embodiment, a system includes a scheduler configured to access a computer-based calendar system for an entity. The scheduler is also configured to access at least one additional computer-based resource configured to identify times during past calendar intervals at which the entity has interacted with the resource. The scheduler is further configured to identify at least one time period during the past calendar intervals when the entity is in a first state for which interaction with the resource indicates performance of work. The scheduler is also configured to prospectively schedule at least one work session during at least one future calendar interval at a time corresponding with the time period when the entity was in the first state.

### PRIORITY CLAIM

The present application claims the priority and benefit of U.S. Provisional Patent Application Ser. No. 62/959,563 filed Jan. 10, 2020, and entitled “SCHEDULE OPTIMIZATION SYSTEM,” the entire contents of which are hereby incorporated by reference.

### FIELD

The present disclosure relates to performing scheduling for an individual or a group.

### BACKGROUND

The statements in this section merely provide background information related to the present disclosure and may not constitute prior art.

In any contemporary work environment, a person may have a very busy day, yet, at the end of that day, that person may find that he or she has not completed tasks that he or she planned to work on that day. One may be diverted from performing the tasks of the day by any number of events that consume one's time. For example, the operation of most any business requires that individuals meet with colleagues or other individuals to discuss projects. As another example, ringing telephones regularly interrupt one's work. Moreover, in today's world, email messages, text messages, and other communications continually consume one's attention from whatever tasks one may have set out to perform each day.

The meetings, telephone calls, email messages, and other messages have to be addressed. At the same time, individuals and groups have to be able to find the time to focus on projects and to have that time protected from interruptions.

### SUMMARY

Disclosed embodiments include systems, computer-implemented methods, and non-transitory computer-readable media storing computer-executable instructions for managing an entity's schedule to identify and protect productive working periods and, when possible, avoiding interrupting a productive working period with meetings and other events that may distract one from productive work.

In an illustrative embodiment, a system includes a scheduler configured to access a computer-based calendar system for an entity. The scheduler is also configured to access at least one additional computer-based resource configured to identify times during past calendar intervals at which the entity has interacted with the resource. The scheduler is further configured to identify at least one time period during the past calendar intervals when the entity is in a first state for which interaction with the resource indicates performance of work. The scheduler is also configured to prospectively schedule at least one work session during at least one future calendar interval at a time corresponding with the time period when the entity was in the first state.

In another illustrative embodiment, a computer-implemented method accesses a computer-based calendar system for an entity. At least one additional computer-based resource is accessed to identify times during past calendar intervals at which the entity has interacted with the resource. At least one time period during the past calendar intervals is identified when the entity is in a first state for which interaction with the resource indicates performance of work. At least one work session is prospectively scheduled during at least one future calendar interval at a time corresponding with the time period when the entity was in the first state.

In still another illustrative embodiment, a non-transitory computer-readable medium storing therein computer-executable instructions to cause a computing system to access a computer-based calendar system for an entity. Executable instructions cause the computing system to access at least one additional computer-based resource configured to identify times during past calendar intervals at which the entity has interacted with the resource. Executable instructions cause the computing system to identify at least one time period during the past calendar intervals when the entity is in a first state for which interaction with the resource indicates performance of work. Executable instructions cause the computing system to prospectively schedule at least one work session during at least one future calendar interval at a time corresponding with the time period when the entity was in the first state.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, with emphasis instead being placed upon illustrating the principles of the disclosed embodiments. In the drawings:

FIG. 1 is a block diagram of an illustrative system for generating a schedule;

FIG. 2 is a more detailed block diagram of the scheduler of FIG. 1;

FIG. 3 is a schematic view of a network environment in which the scheduler of FIGS. 1 and 2 may operate;

FIG. 4 is a block diagram of a representative computing system that may represent a server and other portable and nonportable computing equipment of the network of FIG. 3;

FIG. 5 is a screen view of a work session scheduling screen;

FIG. 6 is a schematic view of an individual's workday calendar;

FIG. 7 is a block diagram of a productive time analyzer and a work session benefit scorer of the scheduler;

FIG. 8 is a screen view of a work session scheduling screen;

FIG. 9 is a schematic diagram showing scheduling of a work session during the workday schedule of FIG. 7;

FIG. 10 is a screen view of another work session scheduling screen;

FIG. 11 is a schematic view of a compositing of workday calendars for the individuals in the group of FIG. 10;

FIG. 12 is a screen view of a calendar event request screen;

FIG. 13 is a block diagram of a calendar event scheduler and a calendar event predictor;

FIGS. 14-17 are block diagrams of examples of calendar event requests being processed by a calendar event scheduler;

FIG. 18 is a screen view of a response to a calendar request;

FIGS. 19 and 20 are screen views providing an individual with alternative responses to calendar requests;

FIG. 21 is a flow diagram of an illustrative method of accessing a calendar system and at least one additional computer-based resource to schedule a work session.

### DETAILED DESCRIPTION

The following description is merely illustrative in nature and is not intended to limit the present disclosure, application, or uses. It will be noted that the first digit of three-digit reference numbers and the first two digits of four-digit reference numbers correspond to the first digit of one-digit figure numbers and the first two digits of two-digit figure numbers, respectively, in which the element first appears.

The following description explains, by way of illustration only and not of limitation, various embodiments of systems, computer-implemented methods, and non-transitory computer-readable media storing computer-executable instructions for scheduling and preserving work sessions for entities including one or more individuals. By way of introduction, the systems, methods, and non-transitory computer-readable media cause a scheduler to accessing a calendar system and at least one computer-based resource for an entity. Based on the entity's engagement of the at least one resource indicating performance of work, at least one period is identified when the entity is in a first state when work was performed. At least one work session is prospectively scheduled during a future calendar interval corresponding with the time period when the entity was in the first state and, thus, performing work.

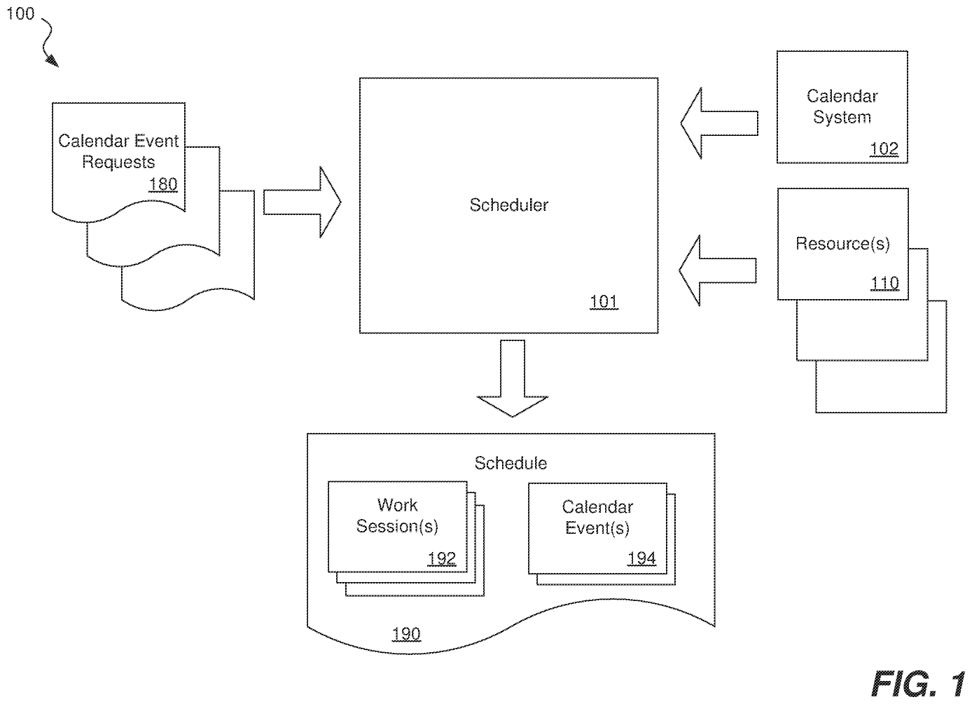

Referring to FIG. 1, in various embodiments a system 100 includes a scheduler 101 that is configured to access a computer-based calendar 102 and one or more computer-based resources 110 for an entity (not shown). The entity may include an individual or a group, such as a group of individuals, assigned to a work team, project group, task force, or any other group involved in a task. Although use of the system 100 with an entity such as a group is also described below, initially, the system 100 is described with reference to an individual's schedule 190.

As further described below, by accessing the calendar 102 and the one or more resources 110 to review the individual's past activities, the scheduler 101 may identify one or more periods where the individual is in a state to perform uninterrupted work. The scheduler 101 is then configured to generate the schedule 190 that may include one or more work sessions 192 assigned for the one or more periods when the individual is in the state for performing uninterrupted work. As will be appreciated, the scheduling of the work sessions 192 protects or otherwise sets aside the periods for uninterrupted work.

By virtue of the scheduler 101 having access to the resources 110, the scheduler 101 does not rely on an individual manually scheduling the work sessions 192 or having the work sessions 192 scheduled by someone else. Although the individual is free to manually schedule work sessions 192, the scheduler 101 may infer from the individual's previous use of the resources 110 when the individual is likely to be in a state where productive and/or uninterrupted work is performed that would be well-suited to scheduling work sessions 192. For example, and as further described below, the scheduler 101 may engage resources 110 such as editing facilities or document or source code library systems to see when the individual has conducted productive work. These times may be well-suited for the scheduling of work sessions 192. Alternatively, the scheduler 101 may engage resources 110 such as communications systems for email or messaging that may indicate that the individual is handling necessary tasks, but because of the interruption-driven or response-driven nature of handling such communications, these times may not be well-suited for scheduling work sessions 192. However, in the interest of scheduling more work sessions 192 to create periods of uninterrupted work, the scheduler 101 may be directed to schedule work sessions 192 during these periods. The scheduler 101 also may be configured to shut down the communications systems during these work sessions 192 to prevent interruptions and facilitate the performance of uninterrupted work during these work sessions 192.

As a result of the scheduler 101 setting work sessions 192 on the schedule 190, when others view the schedule 190 for the individual the work sessions 192 are respected like other scheduled events, such as meetings, conferences, or other sessions on the schedule 192. Thus, when the schedule 190 indicates that an individual has one or more the work sessions 192 at designated times, the individual should be regarded as unavailable for interruptions or other matters unless, for an identifiable reason, some other event should take precedence.

Along these lines, the scheduler 101 receives calendar event requests 180, such as meeting requests or similar events, where another individual or group is requesting time on the individual's schedule 190. As described further below, the scheduler 101 evaluates each of the calendar event requests 180 to determine whether they merit inclusion on the individual's schedule 190. The scheduler 101 generally regards work sessions 192 like other events on the schedule 190 and, thus, the scheduler 101 may deny calendar event requests 180 that conflict with work sessions 192 or other calendar events 194 already on the schedule 190. However, as further described below, if the calendar event requests 180 include attributes, such as relevance to deadlines for the individual, relationship to matters that may be prerequisite to the individual's work, and/or presence of high-ranking individuals or large groups (that may be difficult to schedule), then the scheduler 101 may supersede work sessions 192 or other calendar events 194 on the schedule 190.

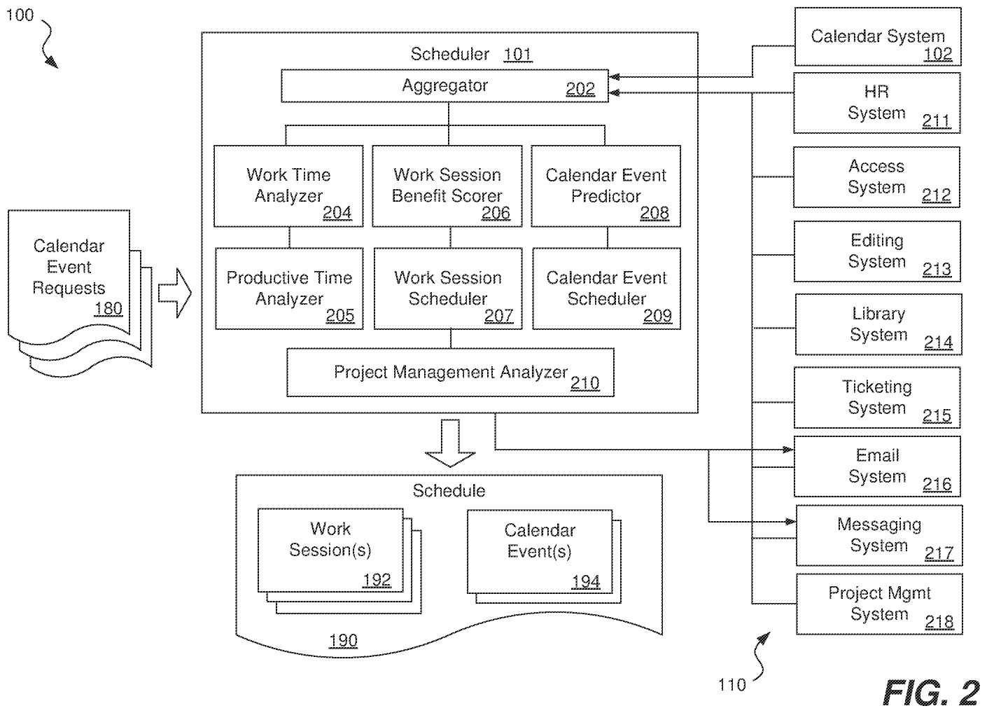

Referring to FIG. 2, the scheduler 101 includes various components and the resources 110 include a variety of systems engageable by the scheduler 101 to generate the schedule 190 that includes work sessions 192 and other calendar events 194. In various embodiments, the scheduler 101 may include an aggregator 202 that is configured to engage the resources 110, gather data from the resources 110, and provide the data to other components of the scheduler 101. In various embodiments, the aggregator 202 may include an executable program that engages resources 110 in the form of other executable programs. In such a case, the aggregator may engage application program interfaces of the other resources or otherwise collect data pertinent to scheduling, as described further below.

The scheduler 101 may include a work time analyzer 204 that determines when the individual is at work, such as a particular individual's working hours or when constituents of a group are present at work. To gather this information, the work time analyzer 204 uses information gathered from a computer-based calendar system 102 on which individuals keep their calendars. Such a calendar system 102 may include a Microsoft Outlook® calendar, a Google Calendar™, or another computer-based calendar system. This information also may be accessed from resources 110 such as a human resources (HR) system 211, which may track an individual's working hours. Access to the HR system 211 may be helpful particularly when an individual has an established work day that may or may not coincide with regular working hours. The HR system 211 also may track individuals that work on flex time or individuals in a job-sharing arrangement so that it can be determined when those individuals or other entities are available. Similarly, the work time analyzer 204 may communicate with an access system 212 that controls when an individual accesses resources or facilities used by the individual when he or she is at work. For example, the access system 212 may include a building security system that may track when an individual arrives at or leaves from a work location by presenting a key card or other indicia to a security system to gain access to the work location. The security system thus may be used to determine what that individual's working hours may be. Similarly, whether the individual works on-site or remotely, the access system 212 may be a computer access facility that tracks when the individual signs on to a corporate computer system from which it may be determined when the individual is at work.

A productive time analyzer 205 may engage resources 110 to determine when an individual historically has or has not engaged in productive work. An individual is considered to have performed productive work when the individual puts forth discernible effort and/or made progress on a task that requires the individual's foremost attention. To perform productive work, therefore, the individual should be free of interruptions or distractions during a period where the individual seeks to perform productive work. In various embodiments, whether an individual is engaged in productive work may be determined in multiple ways.

Considering an example where the individual is a software developer responsible for creating source code. The individual may be able to engage in productive work on source code when he or she is able to work without being interrupted by receiving and responding to emails or other communications. During the time that the individual is answering communications, it is less likely that the individual is creating or editing code. Similarly, the individual's engagement with other resources may demonstrate when the user has been productive in developing source code. For example, when the individual has spent a period of time interacting with a system used to create source code, it may be inferred that the user was productive in working on the source code during that period of time. Similarly, when the individual stores segments of source code in a library system or other system, it may be inferred that the individual was engaged in working on the segments of source code during the period of time before the source code was saved. Thus, the productive time analyzer 205 engages the resources 110 to determine what activities the individual was involved in during various times to determine when the individual was or likely was involved in productive work to identify suitable times to schedule future work sessions.

Referring again to FIG. 2, the productive time analyzer 205 may interact with an editing system 213, a library system 214, or a ticketing system 215 to determine when an individual is engaging in productive work. For example, when the individual used the editing system 213 to create or revise code, documents, or other work files, the productive time analyzer 205 may infer that the individual was engaged in productive work during that time. If the individual logged a file to the library system 214, such as by logging a segment of source code into a source code library or storing a document in a document library, the productive time analyzer 205 may infer that the time preceding the logging of the files was productive time. Similarly, if the individual accessed a ticketing system 215, for example, to update a ticket associated with a programming task to be performed, a coding error to be resolved, etc., the productive time analyzer 205 may infer that the individual was engaged in productive work during the time preceding the updating of the ticket.

Conversely, the productive time analyzer 205 may access communications systems, such as an email system 216 or a messaging system 217, to determine how much the individual has interacted with the systems to identify potentially nonproductive periods of work. When an individual was reading or creating emails, texts, or similar messages, the productive time analyzer 205 may infer that the individual was not creating or editing files that are part of the individual's chief objective. Engaging in communications may be important to enable the individual to further his or her own work or the work of a group. Nonetheless, it can be inferred that the individual was not productively creating source code, documents, or other materials while the individual was actively emailing or messaging others. In various embodiments, the scheduler 101 may be configured to suspend access to communications systems such as the email system 216 and the messaging system 217 during a scheduled work session 192 to help facilitate the individual's performance of uninterrupted, productive work during the work session 192.

In various embodiments, the scheduler 101 also may include a work session benefit scorer 206 and a work session scheduler 207. Based on the output of the productive time analyzer 205, the work session benefit scorer 206 assigns a score to intervals of time as a basis of scheduling work sessions based on when the individual experienced the most productive and/or uninterrupted periods of work. For example, when an individual has spent a period of time engaging an editing system 213, resulting in the logging of segments of source code into a library system 214, the work session benefit scorer 206 may assign a high score to that period of time. The high score, which may be higher than times when an individual spends time on the email system 216, indicates that this is a period of time that may be suitable for a work session and should be protected from unimportant calendar events. Using these scores, the work session scheduler 207, automatically or in response to requests to schedule work sessions, may schedule work sessions during these periods that were assigned high scores based on the individual's work during these periods. The operation of the work session benefit scorer 206 and the work session scheduler 207 are described further below.

In various embodiments, the scheduler 101 also may include a calendar event predictor 208 and a calendar event scheduler 209. Although scheduling work appointments is a priority, it is desirable to schedule calendar events 194, such as meetings, reviews, interviews, demonstrations, and other events that may be important to ongoing operations. Some of these calendar events may be highly relevant to the individual's work, such as meetings with other individuals who may provide information that the individual needs to begin or continue with a project. In order to better evaluate calendar events, the scheduler 201 may use a project management analyzer 210 to access a project management system 218 that maintains data regarding deadlines and priorities of projects, significant personnel or clients associated with particular projects, and similar data. Some calendar events may be particularly significant based on an upcoming deadline. Also, some calendar events, because they involve high-ranking management personnel or customers, or will involve an effort to schedule a large number of people, may be important to schedule.

On the other hand, some calendar events may be less important to schedule because the topic is not time-sensitive and the other individuals involved may present less of a priority. In addition, when a number of meetings are anticipated, for example, in advance of an event such as a product launch or at a start or end of a fiscal year for planning or evaluation purposes, it may be important to further scrutinize proposed calendar events to preserve the opportunity for work sessions 192 to be scheduled and/or preserved. The calendar event predictor 208 and the calendar event scheduler 209 operate to control the introduction of calendar events 194 into the schedule.

To this end, the calendar event predictor 208 projects how many calendar event requests 180 may be expected in a coming interval. As previously mentioned, some meetings may be anticipated at recurring times with the passage of months, quarters, years, or fiscal years. In addition, product launches or other events relating to projects may portend the request for calendar events. To this end, the calendar event predictor 208 may use the project management analyzer 210 to engage the project management system 218 to identify project-related deadlines or other events. Using this data, the calendar event predictor 208 may forecast a number of calendar event requests 180 and, thus, adjust the threshold for a calendar request 180 to satisfy to result in a calendar event 194 being included in the schedule 190.

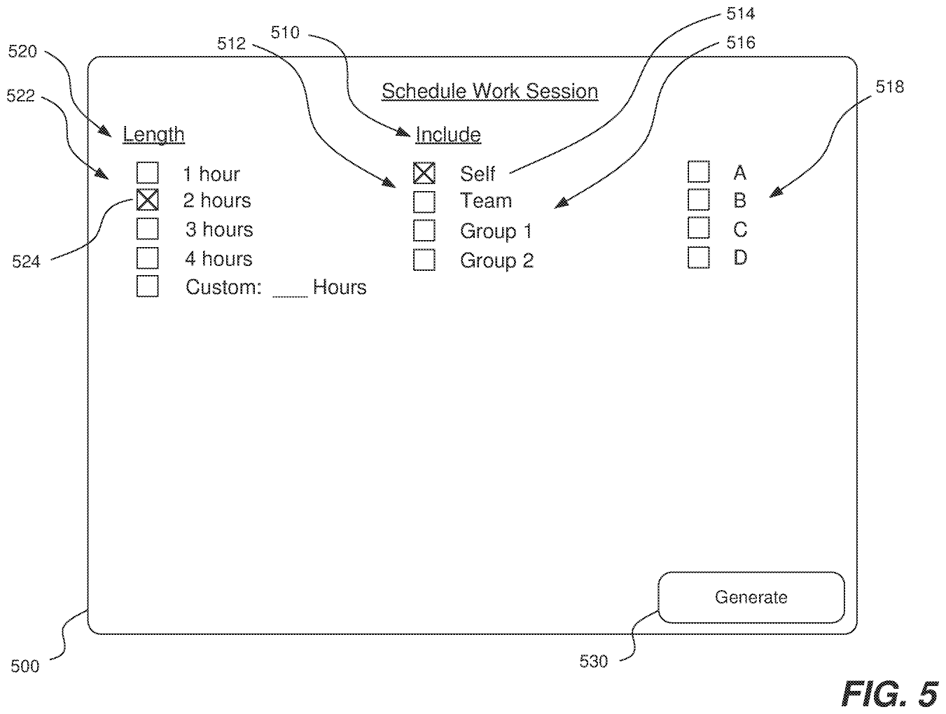

The calendar event scheduler 209, as further described below, uses information produced by the work session benefit scorer 206, the work session scheduler 207, the calendar event predictor 208, and other subsystems to determine which calendar event requests 180 are incorporated into the schedule 190 as calendar events 194. In various embodiments, the calendar event scheduler 209 evaluates attributes presented by the calendar event requests 180 and balances them against scores generated by the work session benefit scorer 206 for work sessions 192. This comparison determines which, if any, calendar event requests 180, in light of projections made by the calendar event predictor 208, have merit that outweighs the priority of work sessions 192 and should be added to the schedule 190 as calendar events 194. Beginning with FIG. 5, examples are described below to expound upon the operation of the scheduler 101 and its various subsystems in conjunction with the computer-based resources 110 to generate the schedule 190 incorporating work sessions 192 and calendar events 194.

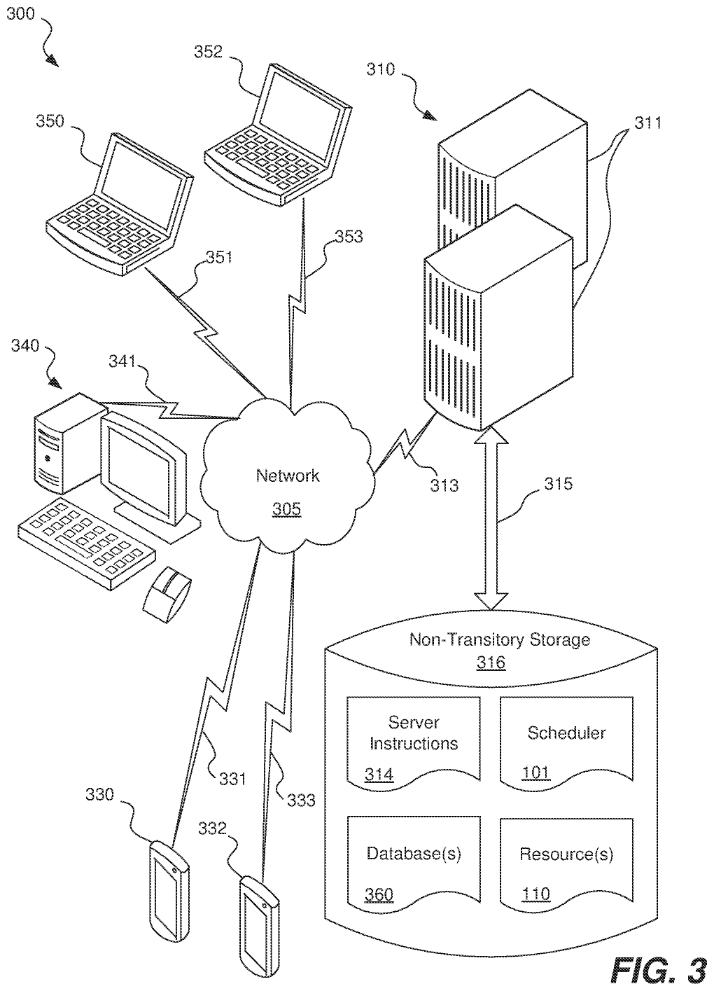

Before further describing the operation of the scheduler 101 and other systems, referring to FIG. 3, an operating environment 300 of the scheduler and other systems is described. The scheduler 101 and other resources 110 are facilitated by computer-executable program code stored on computer-readable media, such as non-transitory storage 316. The non-transitory storage 116 may include direct access hard disk devices, solid-state memory devices, or another storage technology. In various embodiments, the non-transitory storage 116 may store includes server instructions 314, such as operating system software and other utilities used to operate the server computing systems 111 (not shown in FIG. 1). The non-transitory storage 316 may also support one or more databases 360 to manage data for the scheduler 101, the other resources 110, or other modules.

The computer-executable code stored on the non-transitory storage 316 may execute on a server system 310. The server system 310 may include one or more servers 311 arranged in a cluster or server farm configuration. The server system 310 accesses the non-transitory storage 316 via buses or other high-speed channels 315 to access programs and data to process requests for information.

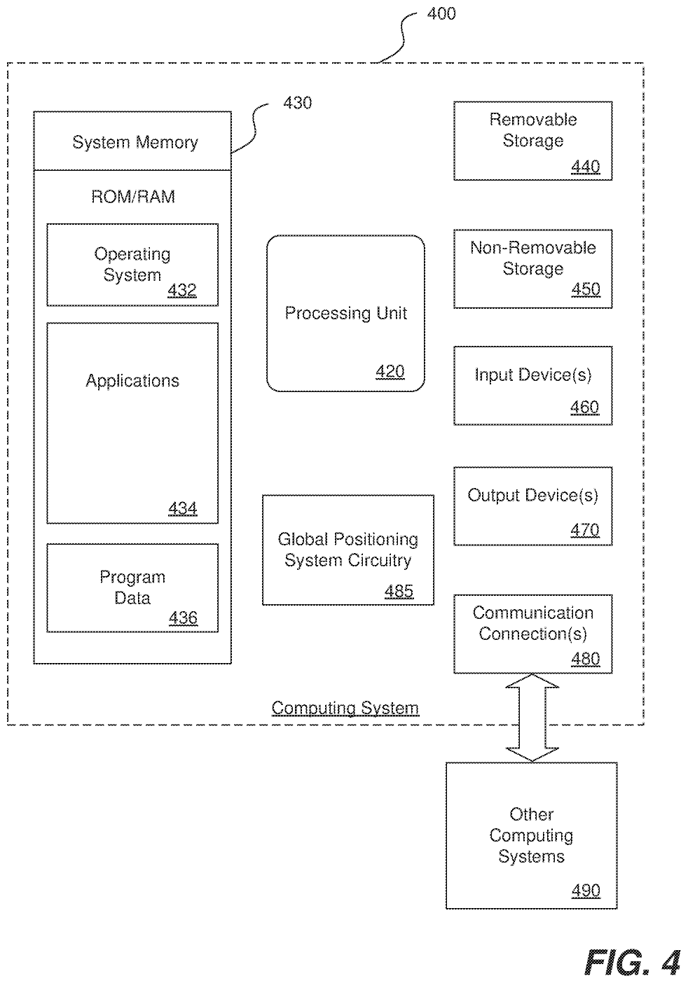

The computer-executable code running on the server system 310 communicates via a network 305 with number of user computing devices. The computing devices may include smartphones (or tablets) 330 and 332, a desktop computer 340, and laptop or notebook computers 350 and 352. The list of portable and nonportable computing systems 330, 332, 340, 350, and 352 are provided for example and illustration and is not intended to be limiting. The use of the designation “computing system,” as described further below, is not intended to suggest any particular type of computer or other device. The designation “computing system” is used to generally encompass any device capable of processing instructions and accessing the server system 310 to provide or retrieve data. The general architecture and structure of the various player computing systems 330, 332, 340, 350, and 352 is described below with reference to FIG. 4.

In various embodiments the server system 310 is coupled to the network 305, which may include the Internet or another computer network, via a network connection 313 (such as a high-speed connection) to provide sufficient bandwidth to support multiple users accessing the server system 310 with minimal latency. The computing systems 330, 332, 340, 350, and 352 connect to the network 305 via communications links 331, 333, 341, 351, and 353, respectively. The communications links 331, 333, 341, 351, and 353 may include wireless data communications link such as provided by cellular-type communications network or a Wi-Fi network that enables communication with the network 305. Other means of wireless communications, such as Bluetooth communications or other means of wireless communication may be used. In addition, although not commonly used with handheld computing systems 330 and 332, the communications links 331, 333, 341, 351, and 353 also may include wired network connections, such as Ethernet connections (which, in the case of a handheld-computing systems 330 and 332 or another portable computing device such as laptop or notebook computing systems 350 and 352, may be provided through a docking station, not shown in FIG. 3). The communications links 331, 333, 341, 351, and 353 may be continuous or switchable links that provide continual access to the network 305 or selective, as-desired access to the network 305, respectively.

It will also be appreciated that the server system 310 and the network 305 may be operated by a third-party provider, such as a commercial web services provider. The various embodiments described do not depend on any particular type of hardware or ownership of the hardware used to support the networked system herein described.

It will be appreciated that many different types of computing systems may be used in the operating environment 300 of FIG. 3. Referring additionally to FIG. 4 and given by way of illustration only and not of limitation, some form of an illustrative computing system 400 may be used for any of the computing systems 330, 332, 340, 350, and 352—as well as the server computing system 310. In such embodiments, the computing system 400 typically includes at least one processing unit 420 and a system memory 430. Depending on the exact configuration and type of computing device, the system memory 430 may be volatile (such as random access memory (“RAM”), non-volatile (such as read-only memory (“ROM”), flash memory, and the like) or some combination of volatile memory and non-volatile memory. The system memory 430 typically maintains an operating system 432, one or more applications 434, and program data 436. The operating system 432 may include any number of operating systems executable on desktop or portable devices including, but not limited to, Linux, Microsoft Windows®, Apple OS®, or Android®. The one or more applications 434 executed on a server system 310 may include the server instructions 314 for operating and managing access to the database 360, as well as the scheduler 101 and the other resources 110.

The computing system 400 may also have additional features or functionality. For example, the computing system 400 may also include additional data storage devices (removable and/or non-removable) such as, for example, magnetic disks, optical disks, tape, or flash memory. Such additional storage is illustrated in FIG. 4 by removable storage 440 and non-removable storage 450. Computer storage media may include volatile and non-volatile, removable and non-removable media implemented in any method or technology for storage of information, such as computer-readable instructions, data structures, program modules or other data. The system memory 430, the removable storage 440, and the non-removable storage 450 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 400. Any such computer storage media may be part of the computing system 400.

The computing system 400 may also have input device(s) 460 such as a keyboard, mouse, pen, voice input device, touchscreen input device, etc. Output device(s) 470 such as a display, speakers, printer, short-range transceivers such as a Bluetooth transceiver, etc., may also be included. The computing system 400 also may include one or more communication connections 480 that allow the computing system 400 to communicate with other computing systems 490, such as over a wired or wireless network or via Bluetooth (a Bluetooth transceiver may be regarded as an input/output device and a communications connection). The one or more communication connections 480 are an example of communication media. Available forms of communication media typically carry computer-readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, RF, infrared and other wireless media. The term computer-readable media as used herein includes both storage media and communication media.

In further reference to FIG. 4, for individuals expected to work from or travel to remote sites, the computing system 400 desirably includes global positioning system (“GPS”) circuitry 485 that can automatically discern its location based on relative positions to multiple GPS satellites. GPS circuitry 485 is commonplace in smartphones and many other tablets or other portable devices. As described further below, GPS circuitry 485 may be used to automatically report a location of an individual at a site, which may be used to determine if an individual is in a location where they may be physically present at a calendar event and/or, if the calendar event is scheduled, whether the calendar event will be conducted using video conferencing or other telecommunications resources.

Referring again to operation of the scheduler 101, the scheduling of work sessions 192 may be performed automatically, periodically, or in response to manual requests. Referring to FIG. 5, a work session scheduling screen 500 permits a user to request a work session to be scheduled for an individual (such as himself or herself) or for a specified group. The work session scheduling screen 500 presents an include option 510 that enables a user to select who is to be included in the work session. The include option 510 includes a list of entities 512 for whom the session is to be scheduled. The list of entities includes a self option 514, to schedule a work session for oneself or a group in which the user intends to be included. The list of entities also includes groups 516 (of which the user may or may not be a member) and other individuals 518 (shown as A, B, C, and D in FIG. 5) that the user may schedule for a work session. The work session scheduling screen 500 also includes a length option 520 that offers choices of duration 522 of the work session. In the example of FIG. 5, to schedule a work session, the user selects a two-hour duration 524 for just himself or herself 512 and selects a generate button 530 to identify possible work sessions.

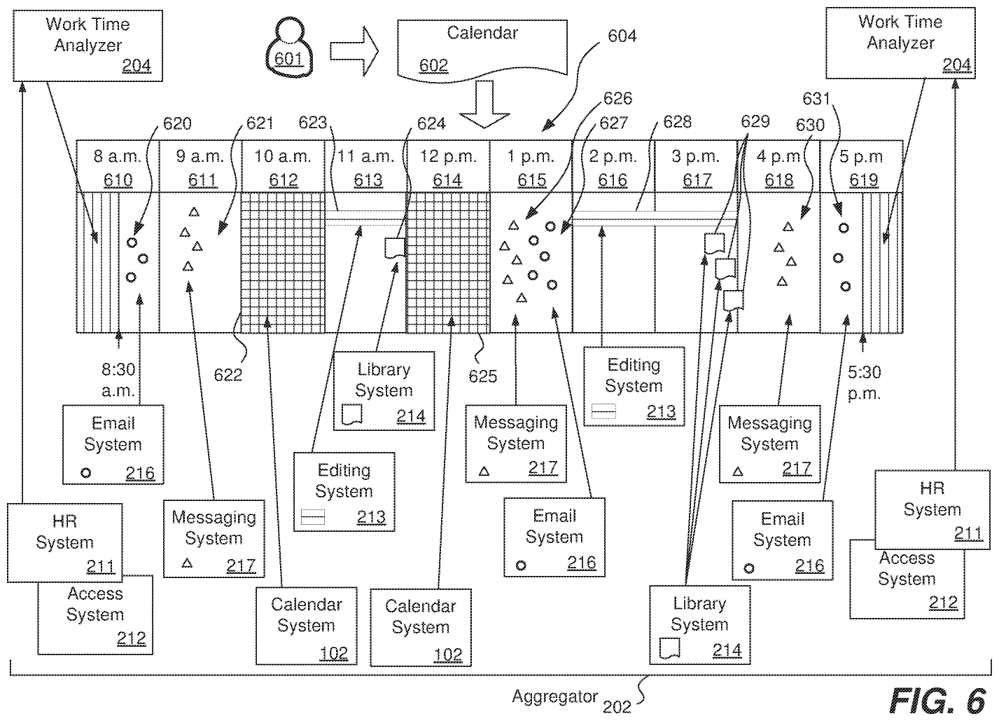

Referring to FIG. 6, on behalf of the various subsystems of the scheduler 101 (FIGS. 1 and 2), the aggregator 202 collects information from the other resources 110 (FIGS. 1 and 2) to generate possible work sessions in response to the request of FIG. 5. It will be appreciated that the scheduler 101 accesses the resources 110 and evaluates the individual's past activities to project the individual's future activities. Using the past activities as a guide, the scheduler 101 can then evaluate how the individual spends his or her time during various time periods and assign scores to those periods to determine good times to schedule work sessions and calendar events, as further described below.

Referring again to FIG. 6, For an individual 601 (the user of the system presenting the work session scheduling screen 500 of FIG. 5), the aggregator accesses a calendar 602 and examines a schedule for a workday 604 for the individual including time periods 610-619 from 8 a.m. through 6:00 p.m. In various embodiments, the aggregator 202 engages the work time analyzer 204 to identify the working hours for the individual 601. As previously described, the work time analyzer 204 may access the human resources system 211 or an access system 212 to determine the working hours for the individual 601. As shown in FIG. 6, the working hours are determined to be from 8:30 a.m. to 5:30 p.m. Using the calendar system 102, the aggregator 202 determines that the individual 601 has appointments on the represented day, including a first appointment 622 from 10:00 a.m. to 11:00 a.m. and a second appointment 625 from 12:00 p.m. to 1:00 p.m.

To identify appropriate times for a work session for the individual 601, the aggregator 202 collects information on the individual's activity throughout the workday 604 for the individual 601. By accessing the email system 216, the aggregator 202 identifies numerous interactions with the email system 216 (represented by circles in FIG. 6) during a time period 610 between 8:30 a.m. and 9:00 a.m., during a time period 615 between 1:00 p.m. and 2:00 p.m. (coincident with interactions with the messaging system 217, as described below), and during a time period 619 between 5:00 p.m. and 5:30 p.m. By accessing the messaging system 217, the aggregator 202 identifies numerous interactions with the messaging system 217 (represented by triangles in FIG. 6) during a time period 611 between 9:00 a.m. and 10:00 a.m., during the time period 615 between 1:00 p.m. and 2:00 p.m. (coincident with interactions with the email system 216, as previously described), and during a time period 618 between 4:00 p.m. and 5:00 p.m. The interactions with the email system 216 and messaging system 217 may represent nontrivial or possibly significant responsibilities for the individual 601 in conducting reporting, responding to customer inquiries or support requests, or other activities. Unless handling the times during which the individual 610 handles these communications is rescheduled, the time periods 610, 611, 615, 618, and 619 during which the individual 610 interacts with the email system 216 and messaging system 217 may not be well-suited to scheduling a work session.

By contrast, by accessing the editing system 213 and the library system 214, the aggregator 202 determines that the individual 610 interacts with the editing system 213 to enter or edit code (represented by a vertically-slashed bar in FIG. 6) during a time period 613 from 11:00 a.m. until 12:00 p.m. and during time periods 616 and 617 from 2:00 p.m. until 4:00 p.m. Also, by accessing the library system 214, the aggregator determines that the individual 601 has logged segments of code or other projects (represented by document icons in FIG. 6) at the conclusion of the time periods 613, 616, and 617. In particular, at the conclusion of the time period 616 and 617 from 2:00 p.m. until 4:00 p.m., the individual 601 logged multiple segments of code or other projects, potentially indicating a high level of productivity.

Based on the information collected by the aggregator 202, the scheduler (not shown in FIG. 6) may infer that the time period 613 from 11:00 a.m. until 12:00 p.m. and the time periods 616 and 617 from 2:00 p.m. until 4:00 p.m. may be well-suited to the scheduling of work sessions. Scheduling of work sessions during these periods may serve as a reminder to the individual to focus on uninterrupted work during those times and may also block those periods from the scheduling of calendar events that would interfere with productive work times. At the same time, those times when the individual is engaging in or reacting to emails and messages during the time periods 610, 611, 615, 618, and 619 may not be well-suited to scheduling a work session because of the interrupt-driven nature of those periods.

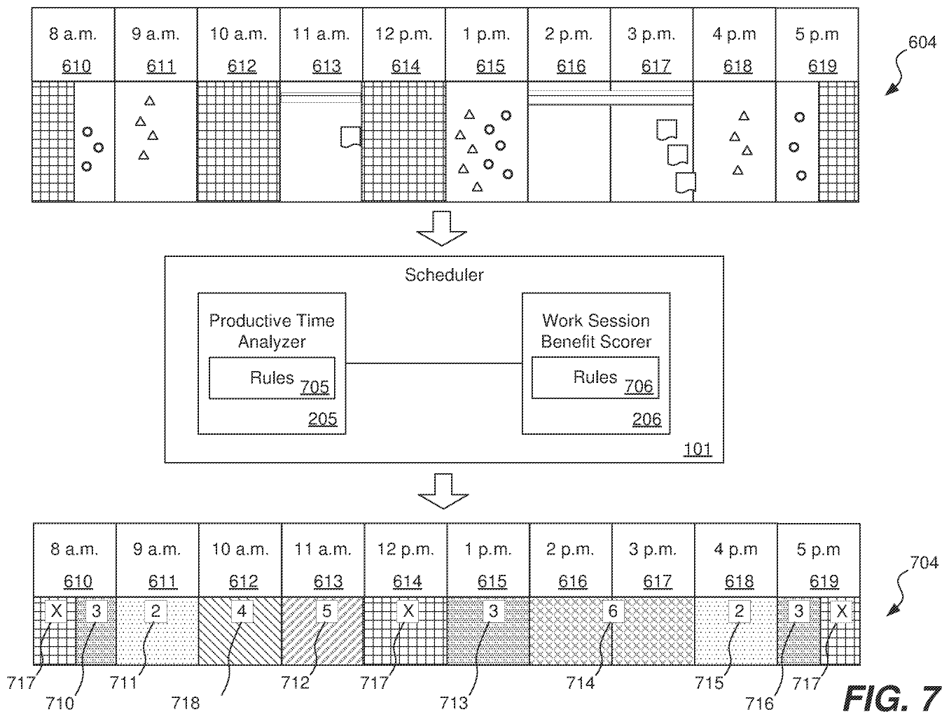

Referring to FIG. 7, after the aggregator 202 (FIGS. 2 and 6) gathers relevant work information as described with reference to FIG. 6, the scheduler 101 may engage other subsystems to ultimately schedule work sessions. First, the productive time analyzer 205 may be engaged to review the information gathered by the aggregator 202 to identify time periods that may present productive work sessions. The productive time analyzer 205 may include a set of rules 705 used to assess an individual's schedule and identify those times that would make for a productive work session and those times that would not. The rules 705 may incorporate concepts such as those previously described with reference to FIG. 6. For example, the rules 705 may acknowledge that times spent working with email and messaging are less well-suited to productive work sessions, while times spent using the editing system 213 or logging documents into the library system 214 are indicative of productive work sessions. Accordingly, the rules 705 may be specified to allow the productive time analyzer 205 to identify productive times that may or may not be suitable for work sessions.

Second, using the evaluation performed by the productive time analyzer 205, in various embodiments, the work session benefit scorer 206 is used to assign scores to the different time periods to reflect which times are better suited for productive work sessions. In various embodiments, it may be useful to assign scores to reflect times that are suited to productive work to provide a basis of numerical comparison a score assigned to a calendar event, as further described below. For example, if the time periods 616 and 617 between 2:00 p.m. and 4:00 p.m. are well-suited to productive work, it may be a good time to schedule a work session. Therefore, the work session benefit scorer 206 may assign a high score to that time period such that only a calendar event of high importance, such as an event relevant to an impending deadline and/or that includes particularly important personnel, may be permitted to supersede productive work time. If the calendar event does not have a score as high as the score assigned to the work session by the work session benefit scorer 206, the calendar event may not be scheduled. Instead, the calendar event may be scheduled during a time period for which the work benefit scorer 206 assigns a lower score, such as during times when the individual usually handles emails. Having the work session benefits scorer 206 assign scores to the different times of day provides the basis for readily determining what events should and should not supersede work sessions.

The work session benefit scorer 206 may incorporate a set of rules 706 that assigns scores to reflect suitability of time for uninterrupted productive work. For example, as previously mentioned, the rules 706 may assign a higher score to periods during which an individual is working with the editing system 213 (which reflects performance of productive work). The rules 706 may assign a still higher score for a period during which the individual works with the editing system 213 and logs a segment of source code in the library system 214 to show that the time spent working with the editing system 213 actually resulted in identifiable work output. Further still, the rules 706 may assign a further increased score for a period where the individual works with the editing system 213 and then logs multiple segments of source code in the library system 214 which may reflect that the individual was particularly productive during that time. By contrast, lesser scores may be assigned to periods where the individual works with emails or messaging, and lesser still when the individual engages with fewer emails or messages or performs no measurable work.

In addition, previously scheduled calendar events may also be assigned a score based on the event's attributes, as further described below. By assigning a score to previously-scheduled calendar events, if subsequent requests for calendar events or work sessions are assigned a higher score, then the previously-scheduled meeting may be preempted by the subsequently-requested calendar events or work sessions.

Embodiments are not limited to any particular type of rules used to calculate scores for an individual's use of time, for work sessions, or for other calendar events. Any type of mathematical, statistical, or heuristic rule may be used, whether established manually, by using machine learning, or otherwise established. Any scoring method described herein is entirely by way of illustration, not limitation.

Referring to the example described with reference to FIG. 6, the work session benefit scorer 206 assigns scores 710-718 to the time periods 610-619 of the workday 604 according to the rules 706, thereby resulting in a scored workday 704. For example, the time period 610 between 8:00 a.m. and 9:00 a.m. may be assigned a score 710 of 3 to represent a value attributable to the individual's task of answering emails during that time. (The time period 610 may include a period from 8:00 a.m. and 8:30 a.m. where the individual is not available for work, as further described below.) The time period 611 between 9:00 a.m. and 10:00 a.m. may be assigned a score 711 of 2 to represent a value attributable to the individual's task of responding to messages. The lower score 711 of 2 may represent a lower value accorded the task of messaging as opposed to answering emails. The lower score 711 of 2 also may reflect relative efficiency in that the individual responds to only one more message during the hour between 9:00 a.m. and 10:00 a.m. as compared to a number of emails addressed in the time period 610 between 8:30 a.m. and 9:00 a.m.

The time period 613 between 11:00 a.m. and 12:00 p.m. is assigned a score 712 of 5. The higher score attributed to this time period relative to the earlier hours may reflect the individual's work with the editing system 213 and eventual logging of files with the library system 214. The time period 615 between 1:00 p.m. and 2:00 p.m. is assigned a score 713 of 3 for responding to emails and messages. The time periods 616 and 617 between 2:00 p.m. and 4:00 p.m., by contrast, are assigned a score 714 of 6, the highest score assigned. The high value may be attributable to the duration of the productive period working with the editing system 213 as well as to the number of files logged with the library system 214 during that time. The time period 618 between 4:00 p.m. and 5:00 p.m. is assigned a score 715 of 2 while the individual handles messages. The time period 619 between 5:00 p.m. and 6:00 p.m. is assigned a score 716 of 3 while the individual handles emails.

It will be appreciated that the scores assigned by the work session benefit scorer 206 are controlled by the rules 706. Thus, if communications via email or messaging were weighed more heavily, periods in which the individual engages in those communications may receive a higher score. Alternatively, for example, if such communications are considered to be less important, further reduced scores may be assigned for these types of tasks.

Scores also may be assigned for previously-scheduled events on the schedule for the workday. For example, times that are out of bounds, such as pre-work hours before 8:30 a.m., post-work hours after 5:30 p.m., and a personal appointment set during the time period 614 between 12:00 p.m. and 1:00 p.m. may be assigned a score 717 (here marked with an “X”) indicating that these times are not available. A previously-scheduled calendar event during the time period 612 from 10:00 a.m. to 11:00 a.m. may be assigned a score 718 of 4 based on attributes of the calendar event, as further described below. In the present example, the score 718 of 4 may reflect that the event is more significant than engaging in email or messaging, but is not as valued as time when the individual is working with the editing system 213 and/or logging files with the library system 214. In this case, it is possible that the calendar event set during the time period 612 may be preempted by a work session or a calendar event assigned a higher score.

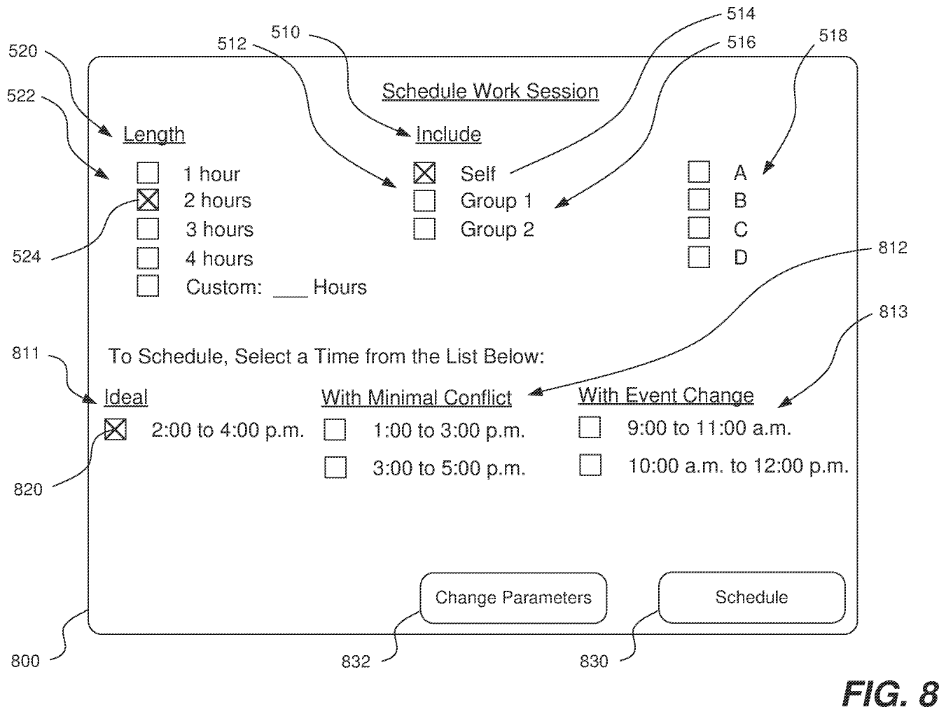

Referring to FIG. 8, in response to the request to schedule a work session generated as described with reference to FIG. 5, the individual is presented with a results screen 800. The results screen 800 lists available work session times, including ideal times 811, times with minimal conflict 812, or times that would require an event change 813. The ideal times are during times when the individual's time has been scored as most productive and that does not conflict with other events on the calendar.

In this case, the ideal time for a work session may be from 2:00 to 4:00 p.m. when, with reference to FIGS. 6 and 7, the individual was highly productive for a sustained duration while using the editing system 213 and in logging files with the library system 214. Scheduling a work session at this time is optimal because the individual is highly productive, and scheduling the work session may protect that productive time. The times with minimal conflict 812 would involve the individual rescheduling activities, such as responding to messages or emails. The times that would require an event change are two-hour periods (the requested duration 524) that would overlap with the previously-scheduled calendar event during the time period 612 from 10:00 a.m. to 11:00 a.m. In this case, the individual opts for the ideal time by marking the selection box 820, and can schedule the work session by selecting the schedule button 830. On the other hand, if the individual is dissatisfied with the offerings, or wishes to change the terms of the individual's previous request, the individual can select the change parameters button 832.

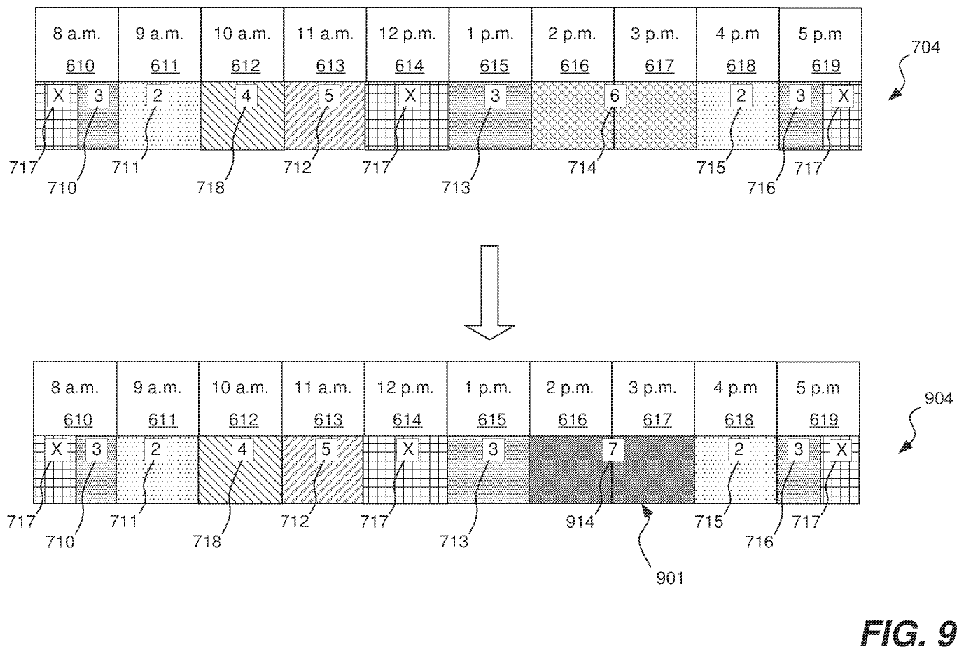

Referring to FIG. 9, with the work session having been scheduled as described with reference to FIG. 8, the change on the workday schedule 704 is reflected to show the updated workday schedule 904. The updated workday schedule 904 includes a work session 901 from 2:00 p.m. until 4:00 p.m. To protect the scheduled work session from being superseded by subsequent scheduling requests, the score 914 is assigned to the period spanned by the work session is increased to 7. The increased score 914 may further allow the individual to protect productive hours to generate work product.

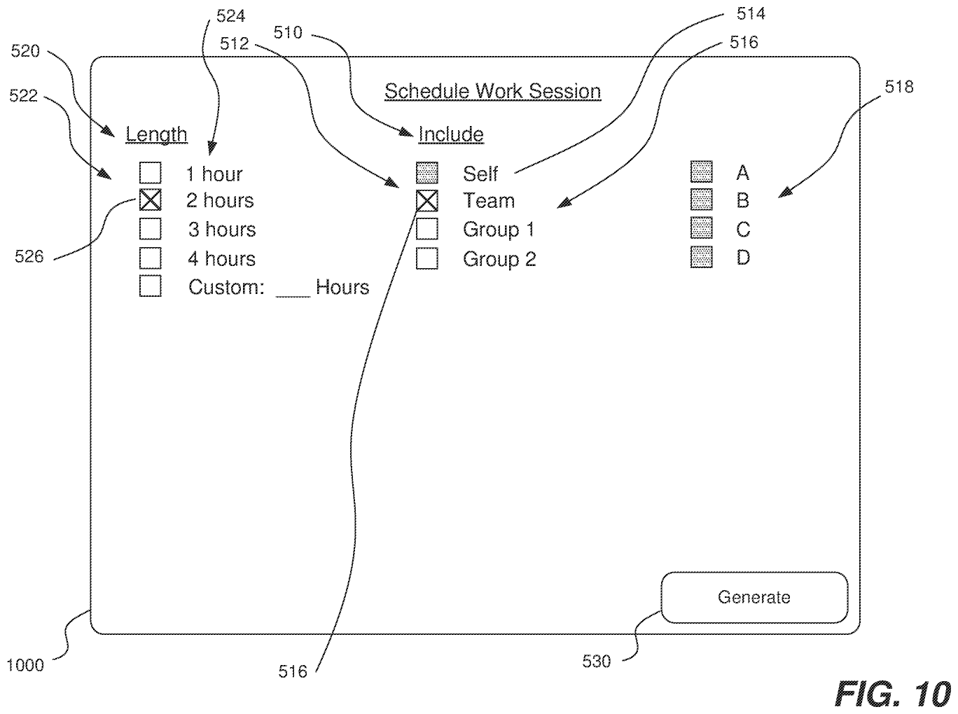

Although the foregoing example of FIGS. 5 through 9 concerned the example of scheduling work sessions for an individual, it will be appreciated that the systems and methods previously described are usable with entities that include individuals or groups of individuals or teams. As such, it will be appreciated that the systems and methods herein described are scalable to schedule work sessions for groups of individuals or teams. Referring to FIG. 10, the work session scheduling screen 500 previously described with reference to FIG. 5 is presented, thereby allowing a user to select from entities 512 that include groups or other individuals. In the example of FIG. 10, the user selects the team option 516. The team option 516 may be associated with all personnel associated with the user's team, thus, selecting the team option automatically includes the user's self 514 and all of the other listed individuals 518. Alternatively, individuals may be selected or unselected to specify a particular list of persons to be included in the work session.

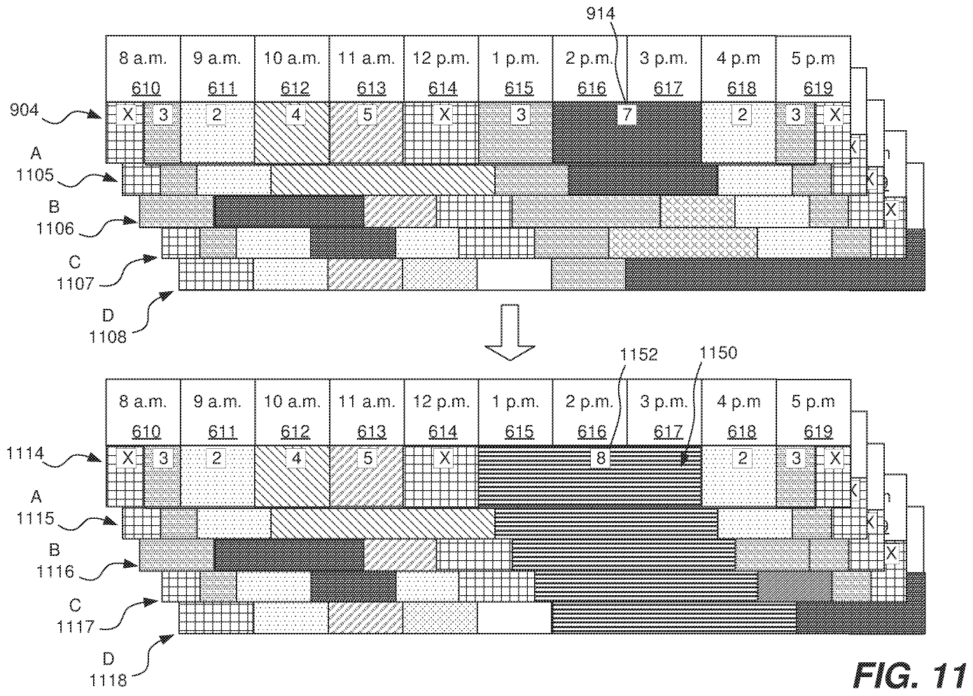

Referring to FIG. 11, and referring back to FIGS. 6 and 7, the scheduler 101 (FIGS. 1 and 2) will access and evaluate the calendars for each of the named individuals, including the individual 601 described with reference to the example of FIGS. 5-9, and the other individuals A, B, C, and D (FIG. 10). For each of the individuals identified in FIG. 10, the aggregator 202 accesses the resources 110 that are engaged or engageable by the individuals. Then, using the productive time analyzer 205 and the work session benefit scorer 206, as described with reference to FIG. 7, scores are assigned for the time periods for the workday calendars 904 and 1105-1108 for the individual 601 and the other individuals A-D. By evaluating the scores for each of the time periods, work sessions are identified, either involving no changes, minimal conflicts, or moving of calendar events, to identify and present options for potential work sessions as described with reference to the individual example of FIG. 8.

After evaluating the workday calendars 904 and 1105-1108, a group work session 1150 is scheduled during the time periods 615-617 between 1:00 p.m. and 4:00 p.m. and for all of the individuals. New workday calendars 1114-1118 are thus generated for each of the individuals, with the group work session 1150 included on each of the workday calendars 1114-1118. The group work session 1150 thus represents a block of time when everyone in the group is aware that everyone is scheduled for a period of productive work. Accordingly, the individuals are made aware that this is a time that they should devote to productive work. The individuals also are aware that they should not interrupt the other individuals associated with the group work session 1150 during this time. As desired, this may be a time when the individuals are working together, but it may be a time when each of the individuals associated with the group work session 1150 can focus on their own work.

To protect the time set aside for the group work session 1150, the work session benefit scorer 206 and the associated rules 706 (FIG. 7) may assign a heightened score 1152 of 8 to the group work session 1150, both to highlight significance of the group work session 1150 and to further protect the group work session 1150 from being superseded by calendar events, as further described below.

It also should be noted that, according to various embodiments, scheduling of the group work session 1150 may dictate that the individuals associated with the group work session 1150 should reschedule other tasks, such as interacting with email or other messaging during that time. These tasks, as previously described with reference to the example of FIGS. 6-9 and represented on the workday calendar 904 for the individual 601 with differently-shaded regions, are similarly denoted on the preexisting workday calendars 1105-1108 for the other individuals. The group work session 1150 may supersede these other tasks on the new workday calendars 1114-1118 Access to email and calendaring may be suspended during this time to direct the individuals associated with the group work session 1150 to focus, for example, on creating or editing source code rather than other tasks which may be accorded less priority.

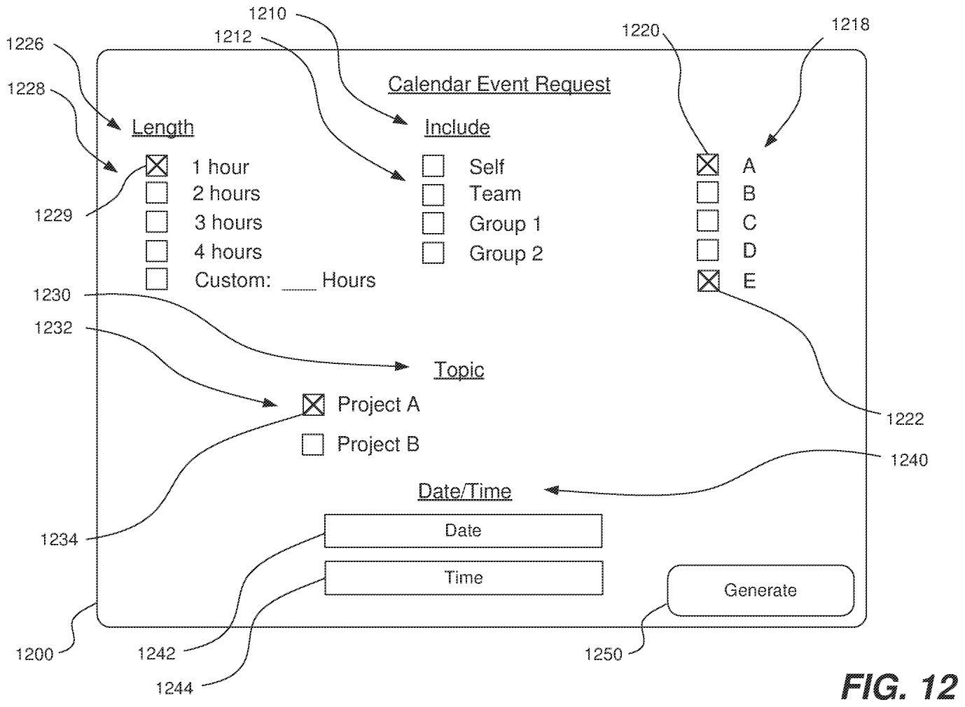

In addition to scheduling work sessions, in various embodiments calendar event scheduling is performed to try to schedule calendar events while protecting work sessions from avoidable interruptions. Referring to FIG. 12, a calendar request screen 1200 allows a user to request to schedule a calendar event, such as a meeting, conference, review, demonstration, or other event. The calendar event request screen 1200 presents an include option 1210, providing a list of entities 1212 that may be included, such as the user himself or herself and pre-established groups or teams. The include option 1210 also presents a list of individuals 1218 that also may be included. In the example of FIG. 12, the user selects options to include individual A 1220 and individual E 1222. The calendar event request screen 1200 also includes a length option 1226 to specify an expected duration of the event from which the user may select from a range of options 1228. In the example of FIG. 12, the user chooses a duration 1229 of one hour. The user also is presented with a date/time option 1240 where the user can specify a date 1242 or a time 1244 for the calendar event.

In addition to the foregoing options, the calendar event request screen 1200 also elicits a topic identifier 1230. The topic identifier 1230 may include a list of known projects 1232 the user may choose. In the example of FIG. 12, the user chooses Project A 1232. As will be described further below, in various embodiments, the number and the significance of the requested attendees specified in the include option 1210 and/or details about the topic specified in the topic identifier 1230 may be used to assess the relative importance of the requested calendar event. These attributes are then evaluated to determine whether the requested calendar event should be scheduled at the requested date and time or, potentially, not be scheduled at all, as described further below. Once the user has specified the attributes of the calendar event on the calendar event request screen 1200, the user may select the generate button 1250 to try to schedule the calendar event.

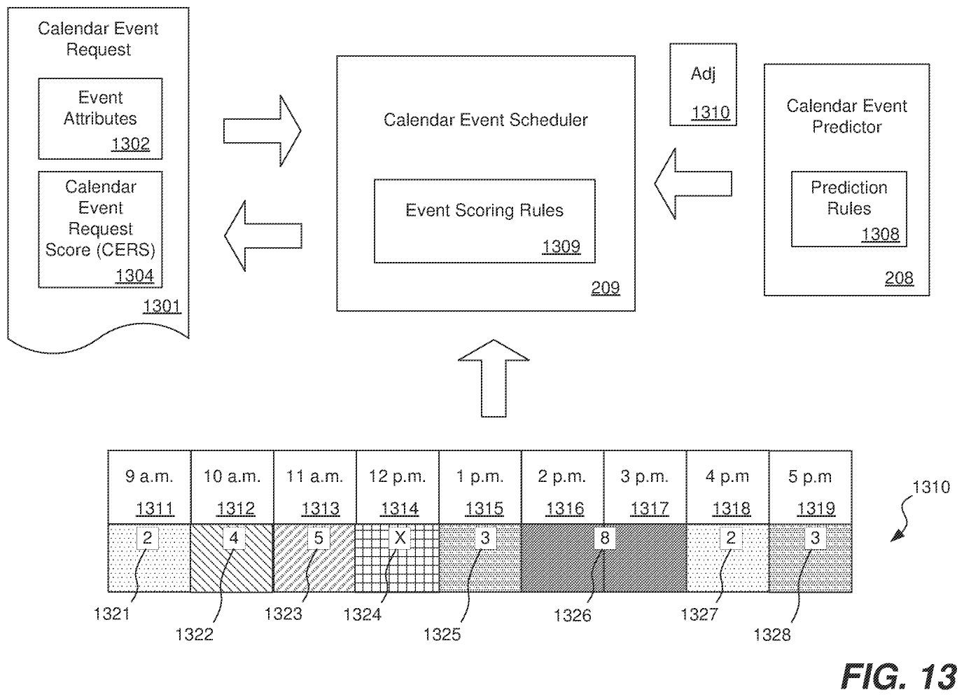

Referring to FIG. 13, a calendar event request 1301 (that represents the calendar event request described with reference to FIG. 12) is passed to the calendar event scheduler 209. In various embodiments, the calendar event scheduler 209, as previously described with reference to FIG. 2, is part of the scheduler 101. The calendar event scheduler 209 operates using a set of event scoring rules 1309 to assign a calendar event request score (CERS in the figures) 1304 to a calendar event request 1301. The resulting score assigned to the calendar event request 1301 may be compared to, for example, the work session benefit scores assigned by the work benefit session scorer 206 as described with reference to FIG. 7. By comparing the assigned scores 1321-1328 for time periods 1321-1328 of the workday 1310, the calendar event request score 1304 may thus be used to determine if the calendar event detailed in the calendar event request 1301 represents a better use of time than a work session 1326 or for other time periods 1311-1315, 1318, and 1319 scheduled for the requested date and time.

The calendar event request 1301 includes a set of event attributes 1302 representing the details of the calendar event specified on the calendar event request screen 1200 (FIG. 12). The calendar event scheduler 209, according to the event scoring rules 1309, uses the event attributes 1302 to generate the calendar event request score 1304. The calendar event scheduler 209, in addition to communicating with other resources 110 (FIGS. 1 and 2), may communicate with the project management system 218 (FIG. 2). The project management system 218 may include events, such as deadlines, product launch dates, project dependencies, personnel working with those projects, and other information. This information may be used by the calendar event scheduler 209 to calculate a calendar event request score 1304 based on the deadlines and other events associated with the topic of the event included in the event attributes 1302. The calendar event request score 1304 may adjust the score based on the role of specified attendees to the project, whether they are related to dependencies for proceeding with the project, the proximity of deadlines, and other considerations.

The calendar event scheduler 209 is also responsive to the calendar event predictor 208, as previously described with reference to FIG. 2. The calendar event predictor 208 uses a set of prediction rules 1308 to, as previously described, predict a number of calendar events that may be forthcoming based on time of the month, quarter, or week, or in conjunction with various projects. The calendar event predictor 208, like the calendar event scheduler 209, in addition to communicating with other resources 110 (FIGS. 1 and 2) may communicate with the project management system 218 (FIG. 2). Because the project management system 218 maintains information about deadlines, product launch dates, and other events, the calendar event predictor 208 thus may use information maintained by the project management system 218 to predict numbers of upcoming events. In various embodiments, the calendar event predictor 208 may render an adjustment 1310 that is used to determine a threshold for a calendar event request score to schedule the calendar event, to adjust values used in calculating the calendar event request score, or in other ways.

The calendar event scheduler 209, informed in various embodiments by the calendar event predictor 208, then compares the calendar event request score 1304 to scores 1321-1328 assigned to time periods 1311-1319 for the workday 1310. Based on the comparison of the calendar event request score 1304 to the scores 1321-1328 for the time period 1310, it may be determined whether and when the calendar event specified by the calendar event request 1301 is scheduled.

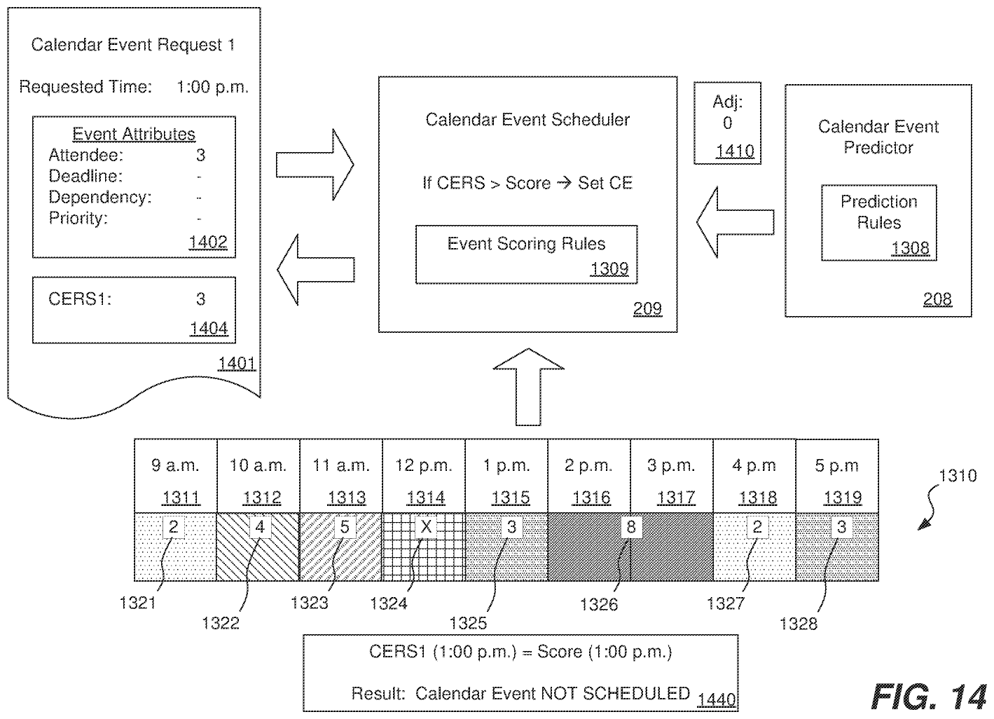

With regard to FIGS. 14-17, a number of example calendar event requests are presented to the calendar event scheduler 209 with differing results. Referring to FIG. 14, a first calendar event request 1401 is presented, seeking a 1:00 p.m. meeting for the workday 1310. The first calendar event request 1401 also includes a number of event attributes 1402. The event attributes 1402 may include information about the attendees, a deadline related to the topic of the calendar event, a project dependency related to the topic of the calendar event, and a priority of the calendar event, any or all of which may be derived from the project management system 218, as previously described. A value assigned to an attendee attribute may be based on a number of attendees, as it may be more difficult to schedule an event for a large number of attendees than for one or a few attendees. The value assigned for an attendee attribute does not necessarily represent a number of attendees, but may represent various sizes of attendee groups, such as there being one score for three or fewer attendees, one value for four to ten attendees, one value for ten to twenty attendees, another value for more than twenty attendees, etc.

Values attributes also may be based on an importance of one or more of the attendees, such as whether the person is a client, an in-demand and/or highly-paid consultant, a high-ranking executive, or other considerations. Values attributed to the deadline may concern the imminence of the deadline or an importance of the deadline to fulfilling a contract, meeting a product release date, etc. A dependency value may be based on an extent to which this calendar event is important for a project to proceed. A priority value may be based on a significance of the topic of the meeting or of the meeting itself. These types of values are examples of the types of attributes which may be considered, and various embodiments are not limited to these attributes or any particular type of attribute value.

It also will be appreciated that the calendar event scheduler 209 is responsive to the calendar event predictor 208 in determining whether to schedule a requested calendar event. In the present example, it is assumed that the calendar event predictor 208, using the prediction rules 209, does not anticipate many or any upcoming events. As a result, the calendar event predictor 208 generates an adjustment 1410 of zero. Thus, the processing of the first calendar event request 1401 is not affected by the likelihood of other upcoming events.

Using the event attributes 1402 and the event scoring rules 1309, the calendar event scheduler assigns a calendar event request score 1404 to the calendar event request 1401. By way of example, the calendar event request score 1404 is then compared to a score associated with the time period for which the calendar event is requested. The calendar event request may be granted and the event scheduled if the calendar event request score 1404 prevails over the score attributed to the time period for the attendees for which the calendar event is requested. The calendar event request score 1404 may prevail over the score for the time period for which the calendar is event is requested by having a larger numeric score. What constitutes a prevailing score may be determined by rules established by the user. For purposes of the example, the workday calendar 1310 is assumed to be a composite for each of the requested attendees. In the example of FIG. 14, the calendar event request score 1404 of 3 is compared to the score 1325 of 3 for the requested time period 1315. For example, when the scheduling rule would schedule the event if the calendar event request score is greater than the score for the requested time, the event would not be scheduled because the calendar event request score 1404 is not greater than the score 1326 for the requested time 1315.

It will be appreciated that a different rule, such as scheduling the event if the calendar event request score is equal to or greater than the score for the requested time, would yield a different result. Embodiments are not limited to any particular formulation of the rules or how attributes are assigned. In addition, instead of declining the calendar event request 1401, alternative event times could be offered, with or without rescheduling other events or matters, as previously described with reference to FIG. 8 with regard to work session scheduling.

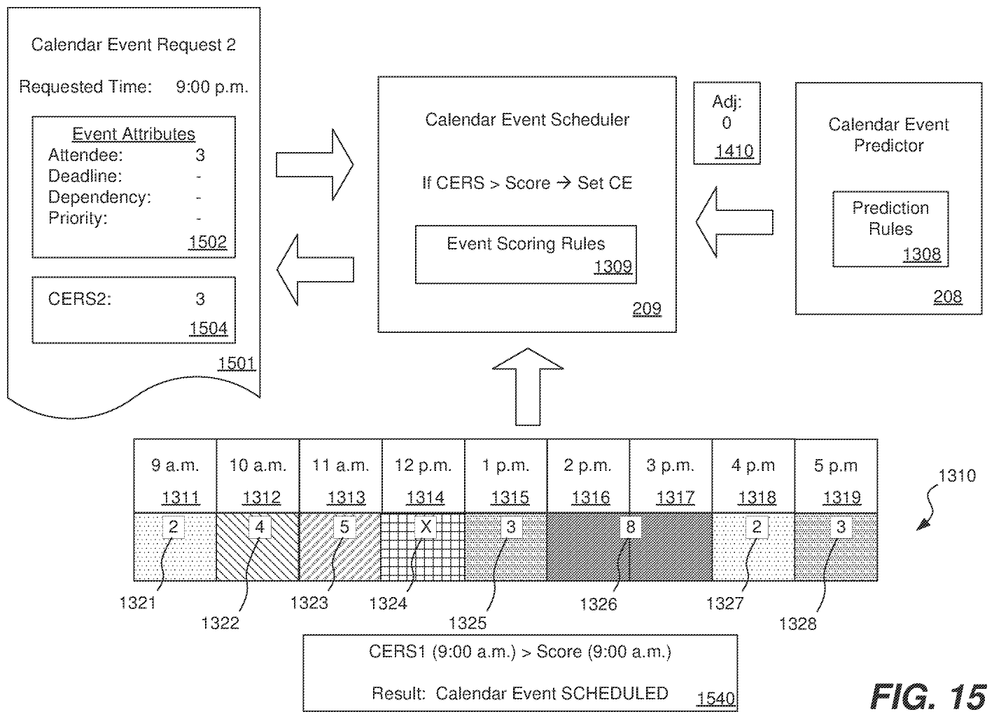

Referring to FIG. 15, a slightly different example is considered for which a second calendar event request 1501 presents event attributes identical to the first calendar event request 1401 (FIG. 14) and is assigned a second calendar event request score 1504 that is the same as the first calendar event request score 1404 assigned to the first calendar event request 1401. However, in the example of FIG. 15, the second calendar event request 1501 specifies a different requested time of 9:00 a.m. Comparing the calendar event request score 1504 for the second calendar request 1501 to the score 1321 assigned to the requested time, the calendar event request score 1504 is higher. Thus, a result 1540 of the second calendar event request 1501 is that the calendar event is scheduled. While the other event attributes 1502 are the same, because of the different time requested, the result 1540 in the example of FIG. 15 is different than the result 1440 in the example of FIG. 14.

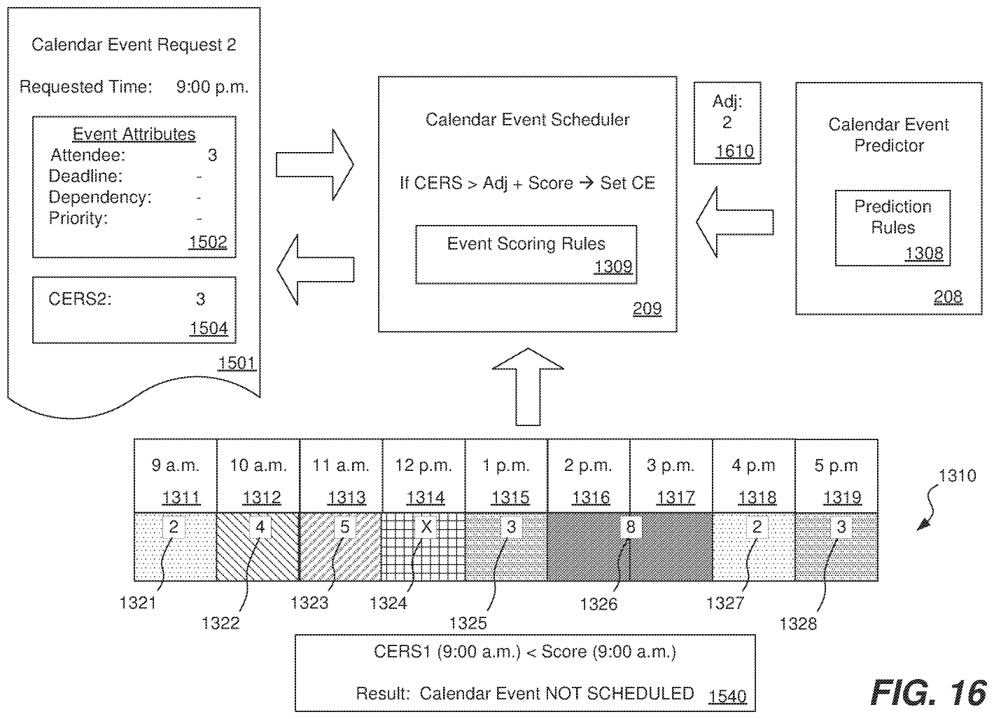

Referring to FIG. 16, another slightly different example is considered for which a same calendar event request 1501 is submitted for the same requested time, but the circumstances are slightly different. In the example of FIG. 16, the calendar event scheduler 209 receives an adjustment 1610 of 2 from the calendar event predictor 208, thereby indicating that calendar events are anticipated for the period of interest. In various embodiments, the adjustment 1610 may be added to or be a multiplier of the score 1321 for the requested time 1311, or otherwise used to adjust the calculus of how the calendar event request score 1504 is compared to the score 1321 for the requested time 1311. In this case, if the adjustment 1610 is added to the score 1321 for the requested time 1311, the calendar event request score 1504 is less than the score 1321 with adjustment. Thus, the result 1540 of the calendar event request 1501 is that the requested event is not scheduled.

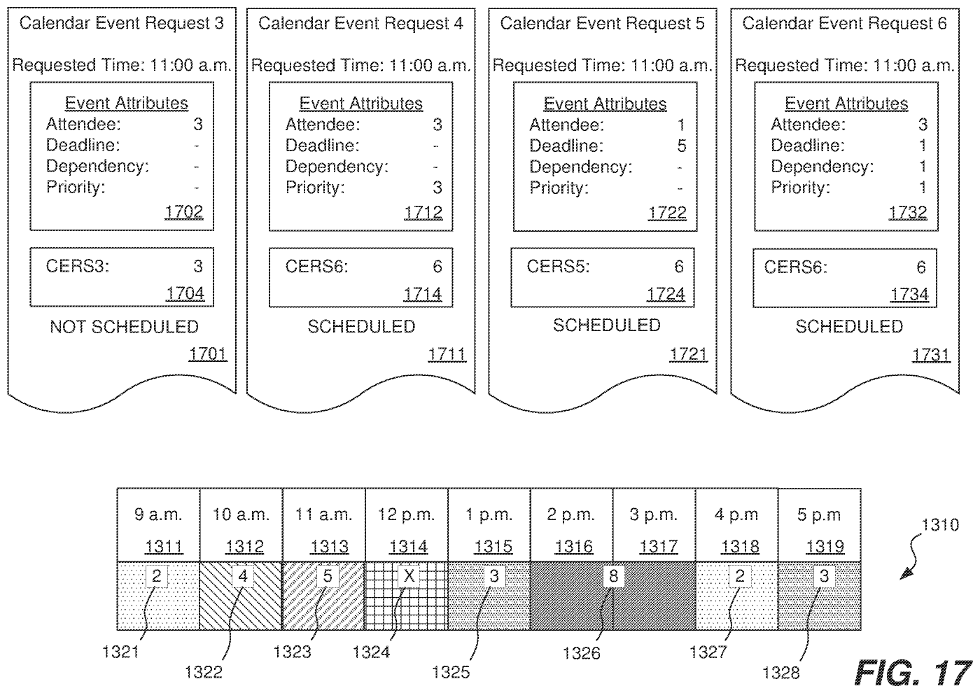

Referring to FIG. 17, examples of additional calendar event requests 1701, 1711, 1721, and 1731 are used to show how calendar event requests are scored for processing based on event attributes 1702, 1712, 1722, and 1732, respectively. In the examples of FIG. 17, it is assumed that the calendar event predictor 208, as previously described with reference to FIGS. 2 and 13-16, does not anticipate calendar events that would indicate an adjustment to the scheduling calculations.

The third calendar event request 1701 requests an event at 11:00 a.m. The calendar event request 1701 is assigned a calendar event request score 1703 of 3 based on the number and/or significance of the attendees. Because the calendar event request score 1704 is less than the score 1323 for the requested time period 1313, the calendar event is not scheduled.

By contrast, the fourth calendar event request 1711 has different event attributes, including a priority attribute of 3. The priority may result from an importance of the calendar event, an associated project, prominence of one or more particular attendees, or other priority factors as recognized by the event scoring rules 1309 (FIGS. 13-16). Adjusting the calendar event request score 1714 for the priority value, the calendar event request score 1714 exceeds the score 1323 assigned to the requested time period 1313 and, thus, the calendar event is scheduled.

The fifth calendar event request 1721 has different event attributes. Although the fifth calendar event request 1721 lacks a high—or any priority—attribute, a high value is attributed to a deadline associated with the event. The high value may be attributed to the importance and/or the imminence of the deadline. Adjusting the calendar event request score 1724 for the deadline value, the calendar event request score 1724 exceeds the score 1323 assigned to the requested time period 1313 and, thus, the calendar event is scheduled.

The sixth calendar event request 1731 also has different event attributes. Although the event attributes 1732 for the fifth calendar event request 1731 include neither a priority attribute like the fourth calendar event request 1711 nor a high deadline attribute like the fifth calendar event request 1731, a combination of attribute values nonetheless result in a high calendar event request score 1734. A combination of an important or impending deadline, a dependency of a project on the event, and a priority associated with the event lead to a high calendar event score 1734 that exceeds the score 1323 assigned to the requested time period 1313. Thus, the calendar event is scheduled—even though no single attribute would cause the requested calendar event to supersede the score 1323 assigned to the requested time period 1313.

If a user submits a calendar request that may create a conflict with working time or other events, various embodiments may propose alternatives or allow individuals to refuse entry of calendar events. Referring back to FIG. 8, as the work session scheduler 207 may generate or propose alternative times for a work session, the calendar event scheduler may generate or propose alternative times for a calendar event. As was the case with the work session scheduler 207, the calendar event scheduler 209 may recommend times having a score that is less than that assigned to the requested time such that scheduling the calendar event at the alternative time will result in less disruption to individuals' already-scheduled events, work sessions, or other activities.

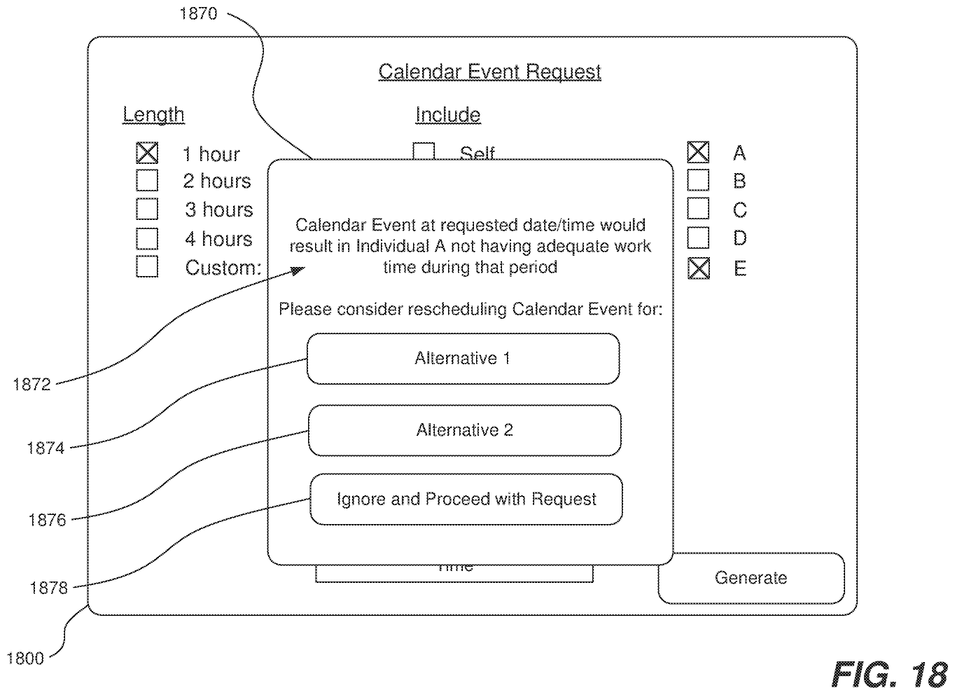

Referring to FIG. 18, in addition, if a user requests a calendar event time that would result in one or more individuals not having a sufficient amount of work time during a day, week, or other period during which the calendar event is sought, the user may be warned. A calendar event request screen 1800 may include an event request response 1870 including an explanation 1872 indicating that scheduling the calendar event proposed by the calendar event request screen 1800 would reduce one or more proposed attendees' working time in a day, week, or other period during which the calendar event was requested. (An amount of time that should be dedicated to working time may be maintained by the scheduler 101 directly or be maintained in the work time analyzer 204, or by another subsystem as described with reference to FIG. 2.) The event request response may propose selectable alternative days or times 1874 and 1876 that would not result in the attendees' work time falling below a threshold. Alternatively, the event request response 1870 may include a selectable accept option 1878 to ignore the warning and proceed with the request despite the potential breach of the work time threshold.

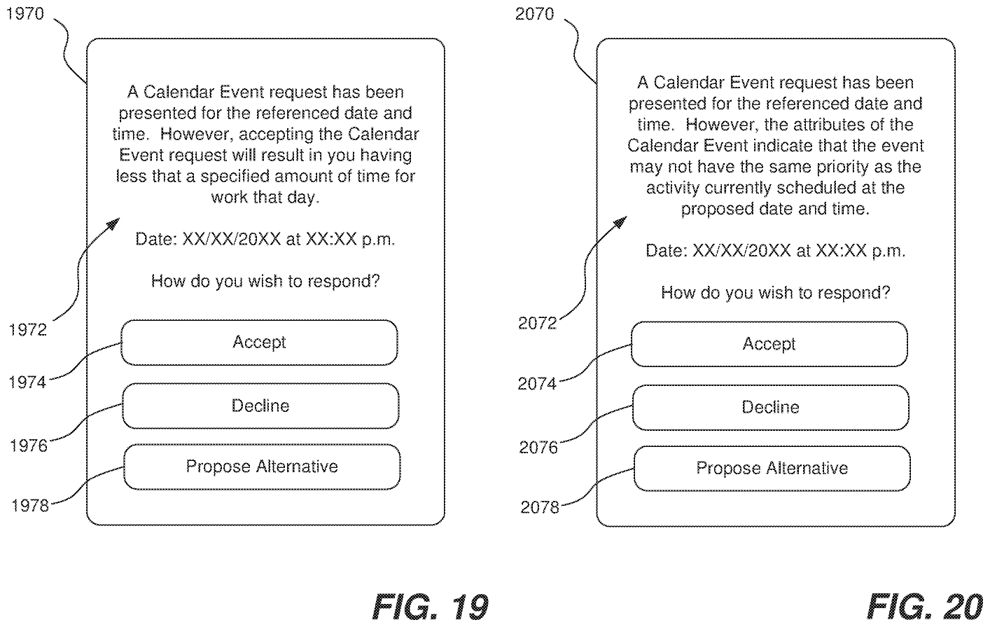

Referring to FIG. 19, in various embodiments, an individual receiving a calendar event request that would prevent the individual from having an adequate, specified time to work in a given period would be presented with a warning message 1970. The individual may receive the warning message 1970, for example, if the user seeking to schedule the calendar event as described with reference to FIG. 18 selected the option 1878 (FIG. 18) to ignore a violation of a work time threshold. Alternatively, in various embodiments the user seeking to schedule the calendar event may not be warned when scheduling an event would prevent an individual from having adequate time to work during that period, but the individual may nonetheless receive the warning message 1970. The warning message 1970 may include an explanation 1972 of the issue. The warning message 1970 also may include an accept option 1974 to schedule the calendar event despite the issue. The warning message 1970 also may include a decline option 1976 to refuse to schedule the calendar event as a result of the problem. In addition, the warning message 1970 may include a propose alternative option 1978 to enable the individual to propose other times for the calendar event that may not encroach on work time that is or should be set aside for the period at issue.

Various embodiments describe calendar events being automatically scheduled or refused based on scores assigned to the calendar event request and other events with which the calendar event request may conflict. However, as described with reference to FIG. 19, an individual whose participation is requested in a calendar event may be prompted to manually respond to calendar event requests. Referring to FIG. 20, in various embodiments, an individual receiving a calendar event request may manually respond to the request. An event request message 2070 may include an explanation 2072 of how the requested calendar event may affect the individual's calendar. The event request message 2070 also may include an accept option 2074 to schedule the calendar event. The event request message 2070 also may include a decline option 2076 to refuse to schedule the calendar event. In addition, the event request message 2070 may include a propose alternative option 2078 to enable the individual to propose other times for the calendar event.

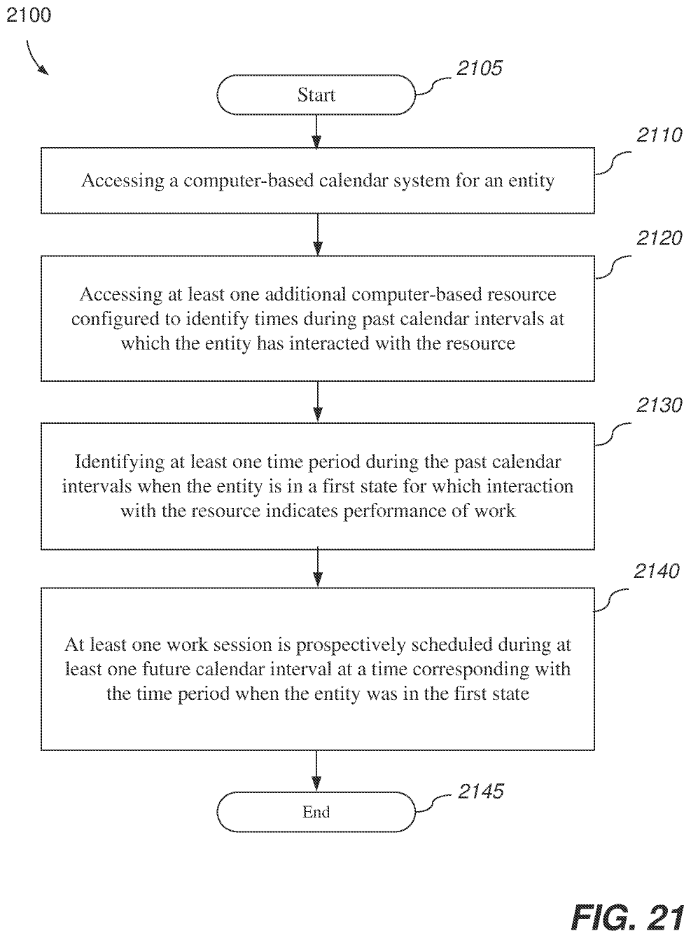

Referring additionally to FIG. 21, a flow diagram represents an illustrative method 2100 of scheduling a work session for an entity, such as a group of one or more individuals. The method 2100 starts at a block 2105. At a block 2110, a computer-based calendar system for an entity is accessed, as previously described with reference to FIGS. 1, 2, and 6. At a block 2120, at least one additional computer-based resource configured to identify times during past calendar intervals at which the entity has interacted with the resource is accessed, as previously described with reference to FIG. 6. At a block 2130, at least one time period during the past calendar intervals when the entity is in a first state is identified, where interaction with the resource indicates performance of work, as previously described with reference to FIG. 7. At a block 2140, at least one work session is prospectively scheduled during at least one future calendar interval at a time corresponding with the time period when the entity was in the first state, as previously described with reference to FIG. 9. The method 2100 ends at a block 2145.

It will be appreciated that the detailed description set forth above is merely illustrative in nature and variations that do not depart from the gist and/or spirit of the claimed subject matter are intended to be within the scope of the claims. Such variations are not to be regarded as a departure from the spirit and scope of the claimed subject matter.

1. A system comprising:
a scheduler configured to:
access a computer-based calendar system for at least one entity chosen from an individual and a group of individuals;
access at least one additional computer-based resource configured to identify times during past calendar intervals at which the at least one entity has interacted with the at least one resource;
identify at least one time period during the past calendar intervals when the at least one entity is in a first state for which interaction with the at least one resource indicates performance of work; and
prospectively schedule at least one work session during at least one future calendar interval at a time corresponding with the time period when the at least one entity was in the first state.

2-21. (canceled)

22. A computer-implemented method comprising:
accessing a computer-based calendar system for at least one entity chosen from an individual and a group of individuals;
accessing at least one additional computer-based resource configured to identify times during past calendar intervals at which the at least one entity has interacted with the at least one resource;
identifying at least one time period during the past calendar intervals when the at least one entity is in a first state for which interaction with the at least one resource indicates performance of work; and
prospectively scheduling at least one work session during at least one future calendar interval at a time corresponding with the time period when the at least one entity was in the first state.

23-42. (canceled)

43. A non-transitory computer-readable medium storing therein computer-executable instructions to cause a computing system to:
access a computer-based calendar system for at least one entity chosen from an individual and a group of individuals;
access at least one additional computer-based resource configured to identify times during past calendar intervals at which the at least one entity has interacted with the at least one resource;
identify at least one time period during the past calendar intervals when the at least one entity is in a first state for which interaction with the at least one resource indicates performance of work; and
prospectively schedule at least one work session during at least one future calendar interval at a time corresponding with the time period when the at least one entity was in the first state.

44. (canceled)

45. The non-transitory computer-readable medium of claim 43, further comprising computer-executable instructions configured to determine that the at least one entity is in the first state during the time period that the entity interacts with the at least one resource.

46. The non-transitory computer-readable medium of claim 45, wherein the at least one resource includes an editing system with which the at least one entity interacts while performing work.

47. The non-transitory computer-readable medium of claim 46, further comprising computer-executable instructions configured to determine that the at least one entity is in the first state prior to interacting with the at least one resource when the at least one resource is configured to receive identifiable work product from the at least one entity.

48. The non-transitory computer-readable medium of claim 47, wherein the at least one resource is chosen from: a ticketing system, wherein a task is associated with a ticket and the entity makes a change to a ticket to indicate progress on the task associated with the ticket, and a library system, wherein entry of a file in the library indicates performance of work on the file.

49. The non-transitory computer-readable medium of claim 43, wherein the interaction with the at least one resource by the at least one entity indicates that the at least one entity is not engaged in productive work during the times at which at which the at least one entity has interaction with the at least one resource.

50. The non-transitory computer-readable medium of claim 49, wherein the at least one resource includes at least one communications resource chosen from an email system and a messaging system.

51. The non-transitory computer-readable medium of claim 49, further comprising computer-executable instructions configured to suppress access to the at least one resource by the at least one entity during the work session.

52. The non-transitory computer-readable medium of claim 43, further comprising computer-executable instructions configured to access a project management analyzer configured to access at least one element of project management data for the at least one entity chosen from deadline data for a project assigned to the at least one entity and dependency data indicating one of information and an event on which completion of the project depends.

53. The non-transitory computer-readable medium of claim 43, further comprising computer-executable instructions configured to access at least one additional system chosen from a human resources system and an access system to determine working hours of the at least one entity.

54. The non-transitory computer-readable medium of claim 43, further comprising computer-executable instructions configured to assign a score to a time period representative of a value of work performed during that time period.

55. The non-transitory computer-readable medium of claim 54, further comprising computer-executable instructions configured to increase the score assigned to a group work session to reflect priority to be accorded to time assigned for a group to engage in work.

56. The non-transitory computer-readable medium of claim 54, further comprising computer-executable instructions configured to assign a calendar event request score to a calendar event request based on at least one attribute associated with a calendar event request, wherein the calendar event is scheduled when the calendar event request score surpasses a score for the time period for which the calendar event is requested.

57. (canceled)

58. The non-transitory computer-readable medium of claim 56, further comprising computer-executable instructions configured to perform at least one additional function chosen from moving an existing activity and proposing moving an existing activity if the calendar event request score for the calendar event request prevails over the score for the time period for which the calendar event is requested.

59. The non-transitory computer-readable medium of claim 56, further comprising computer-executable instructions configured to identify at least one or more alternative calendar event times having a score that is surpassed by the calendar event request score.

60. The non-transitory computer-readable medium of claim 56, wherein the at least one attribute associated with a calendar event request is chosen from a priority of one or more event attendees, a relationship of the calendar event request to a deadline, a dependency of a project upon the event being held, and a priority of the event.

61. The non-transitory computer-readable medium of claim 56, further comprising computer-executable instructions configured to receive an adjustment from a calendar event predictor for use in evaluating the calendar event request considering a number of predicted calendar events.

62. The non-transitory computer-readable medium of claim 56, further comprising computer-executable instructions configured to identify when adding the calendar event for an entity requested for the calendar event request would result in non-calendar event time for the requested entity would fall below a threshold set to allow a minimum amount of work time for the requested entity.

63. (canceled)
